(19) United States
(12) Patent Application Publication
(10) Pub. No.: US 2012/0256500 A1
(43) Pub. Date: Oct. 11, 2012

(54) ELECTRIC MOTOR

(75) Inventors: Thomas Mann, Nidderau (DE); Wolfram Triller, Wiesbaden (DE)

(73) Assignee: Continental Automotive GmbH, Hannover (DE)

(21) Appl. No.: 13/516,964

(22) PCT Filed: Dec. 16, 2010
(86) PCT No.: PCT/EP2010/069876

§ 371 Date: Jun. 18, 2012

(30) Foreign Application Priority Data
Dec. 18, 2009 (DE) 10 2009 059 116.8

(51) Int. Cl. H02K 1/28

(52) U.S. Cl. 310/43

(57) ABSTRACT

An electric motor, having a stator, on which a coil for generating a commutated magnetic rotating field, and a rotor having a permanent magnet element. The rotor is mounted rotatably on an axis. A force acts between the commutated magnetic rotating field and the magnetic field of the permanent magnet element to rotate the rotor about the axis. To provide an electric motor in which the permanent magnet element is fastened on the rotor in a cost-effective and long-term stable manner. The torque generated by the electric motor should be as large as possible, the permanent magnet element protrudes in an axial extension thereof beyond the stator. The part of the permanent magnetic element that protrudes beyond the stator is covered by an overmolding made of a plastic material, said overmolding fixes the permanent magnet element in the position thereof on the rotor.

### CROSS REFERENCE TO RELATED APPLICATIONS

This is a U.S. national stage of application No. PCT/EP2010/069876, filed on 16 Dec. 2010. Priority is claimed on German Application No.: 10 2009 059 116.8 filed 18 Dec. 2009, the content of which is incorporated here by reference.

### BACKGROUND OF THE INVENTION

1. Field of the Invention

The invention relates to an electric motor having a stator, on which at least one coil for producing a commutated magnetic rotating field is formed, and a rotor, on which at least one permanent magnet element is formed, wherein the rotor is rotatably mounted on an axis and wherein a force that turns the rotor about its axis acts between the commutated magnetic rotating field and the magnetic field of the permanent magnet element.

2. Description of Prior Art

Electric motors of the kind mentioned in the introduction are known and they are widely used. There are different methods for fixing the permanent magnet elements on the rotor. For example, it is known to completely overmold the permanent magnet elements with a plastic and thus fix them to the rotor. In doing so, however, the distance between the permanent magnet elements and the coils on the stator is increased, as a result of which the force that occurs between the magnetic fields of the coils and those of the permanent magnet elements is reduced. In addition to the plastic overmolding, an air gap, which compensates for the unavoidable production and bearing tolerances, must remain between the inside diameter of the stator and the outside diameter of the rotor. The bearing on the axis of the rotor, which allows the rotor to turn, cannot be manufactured so that it is completely free from play, and this bearing play can also increase in the course of operation of the electric motor. An air gap in the electric motor between the inside diameter of the stator and the outside diameter of the rotor is therefore always necessary. Complete overmolding of the rotor with plastic to fix the permanent magnet elements therefore reduces the performance capability of the electric motor.

The permanent magnet elements can also be glued to the rotor. However, this is a very difficult and therefore an expensive process, which often leads to unsatisfactory results.

### SUMMARY OF THE INVENTION

It is therefore an object of the present invention to specify an electric motor in which the at least one permanent magnet element is fixed to the rotor cost-effectively and with long-term stability, wherein the torques produced by the electric motor are as large as possible.

As the at least one permanent magnet element projects beyond the stator in its axial extension, wherein only that part of the permanent magnet element that projects beyond the stator is covered by a plastic overmolding, wherein this overmolding fixes the permanent magnet element in its position on the rotor, the distance between the coil on the stator and the permanent magnet element on the rotor can be made particularly small. This increases the performance capability of the electric motor, as it can produce a larger torque due to the interaction of the fields with higher field strength. The magnetic field strength close to the coil and close to the permanent magnet element is higher than when the distance is greater.

The permanent magnet element projects beyond the stator in its axial extension at both ends, wherein only those parts of the permanent magnet element that project beyond the stator are covered by the plastic overmoldings and wherein these overmoldings fix the permanent magnet element in its position on the rotor. The parts of the permanent magnet elements which project beyond the stator are particularly well fixed due to the overmolding on both sides, which enables a long life of the electric motor. This symmetrical structure of the rotor guarantees particularly good running of the electric motor.

If, at least at one end of the rotor, the outside diameter of the overmolding is no greater than the inside diameter of the stator, the rotor equipped with the permanent magnet elements can be slid into the stator without any problems. In doing so, the whole overmolding is slid through the stator until it emerges therefrom at the other end of the stator as a result of the axial extension of the permanent magnet elements. After the overmolding emerges from the rotor, only the necessary air gap between the rotor and the stator remains in the rotor, wherein the air gap is necessary in order to compensate for bearing tolerances.

In one embodiment, the overmolding is formed in one piece with bars, wherein the bars are anchored in the rotor and therefore additionally fix the at least one permanent magnet element. As a result, a one-piece cage, which fixes the permanent magnet elements outstandingly well and therefore enables the position of the permanent magnet elements on the rotor to be controlled very accurately, is produced by the overmolding and the bars.

It is advantageous when the anchoring of the bars is in the form of an undercut. This form of the anchoring with the injection molding achieves a secure and reliable fixing of the bars and therefore of the whole cage comprising the one-piece combination of bars and overmolding.

In an improvement, the at least one overmolding is used as an aid for installing the rotor in the stator. As the rotor is provided with permanent magnet elements, it is attracted by the metal of the stator. If the permanent magnet elements knock against the stator, the installation process has failed and, as a rule, the electric motor will have become unusable. Here, the overmolding can be used as an installation aid, as it guarantees the distance between the permanent magnet elements and the stator until the rotor has slid into its position and is then held thereby on its axis of rotation.

If the permanent magnet element is cuboid-shaped, it can be manufactured very easily and cost effectively. The cuboid-shaped permanent magnet element is also qualitatively superior to a cylindrical-shell-shaped permanent magnet element, as the permanent magnet field of the cuboid-shaped permanent magnet element can be more homogeneous.

### BRIEF DESCRIPTION OF THE DRAWINGS

The invention is described in more detail below with reference to the figures. In the drawing:

FIG. 1 is an electric motor;

FIG. 2 is the structure of the rotor;

FIG. 3 is a lateral section of the rotor;

FIG. 4 is a section through the rotor along the line D-D;

FIG. 5 is a section through the rotor along the line A-A;

FIG. 6 is a schematic structure of the electric motor according to one embodiment of the invention; and

FIG. 7 is an electric motor 1 according to the prior art.

### DETAILED DESCRIPTION OF THE PRESENTLY PREFERRED EMBODIMENTS

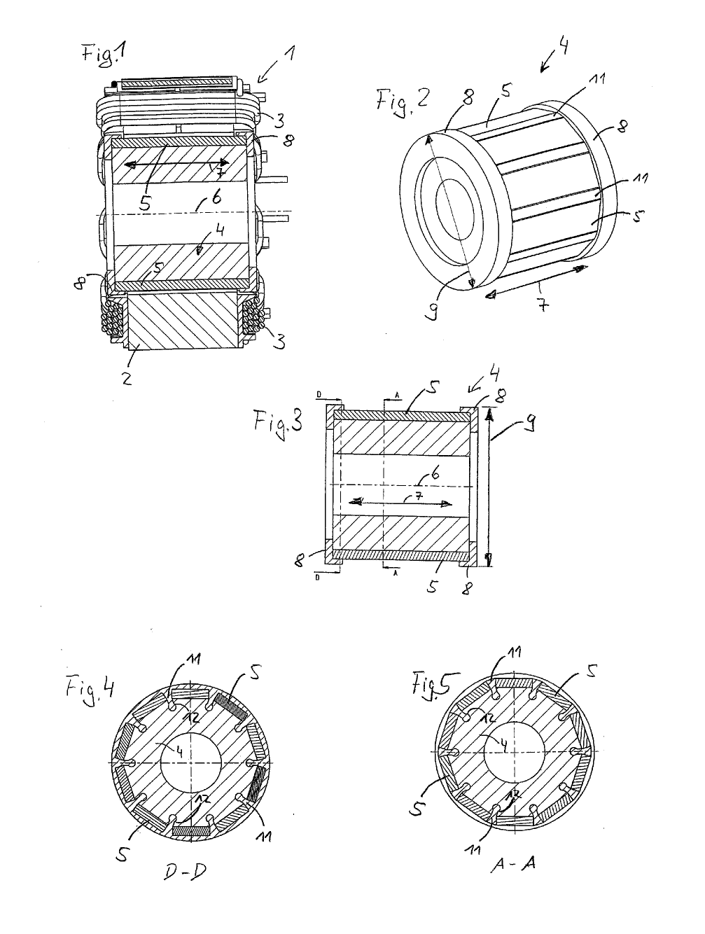

FIG. 1 shows an electric motor 1 having a stator 2 and a rotor 4. Coils 3, through which a commutated electric current, by which a magnetic alternating field is produced, can pass, are fitted on the stator 2. The rotor 4 is rotatably mounted on an axis 6 and it has permanent magnet elements 5. These permanent magnet elements 5 are held on the rotor 4 by an overmolding 8. For this purpose, the at least one permanent magnet element 5 projects beyond the stator 4 in its axial extension 7 (FIG. 2). The overmolding 8 encompasses only that part of the permanent magnet elements 5 that projects beyond the stator 2. This design of the stator 2 enables the distance between the permanent magnet elements 5 and the stator 2 to be made particularly small. Here, this distance is limited to the air gap that must be present between the stator and the rotor 4 to compensate for bearing play of the rotor 4 and the manufacturing tolerances of the stator 2 and of the rotor 4.

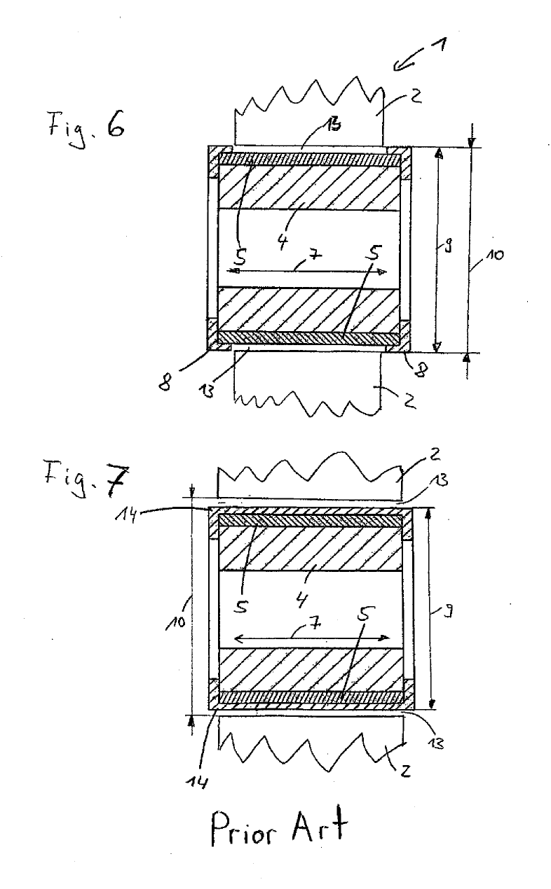

The structure of the rotor 4 is shown in more detail in FIG. 2. A multiplicity of permanent magnet elements 5, which are arranged on the cylindrical outer surface of the stator 2, can be seen. Here, the permanent magnet elements 5 are cuboid-shaped. That part of the permanent magnet elements 5 that projects beyond the stator 2 in its axial extension 7 is covered by a plastic overmolding 8. This plastic overmolding 8 fixes the permanent magnet elements 5 on the outer surface of the cylindrical rotor 4. Bars 11, which enable a further fixing of the permanent magnet elements 5 to the rotor 4, can be seen between the permanent magnet elements 5. Furthermore, the outside diameter 9 of the rotor 4 is shown in FIG. 2. The outside diameter 9 of the rotor 4 is formed by the rotor 4 equipped with the permanent magnet elements 5 and the overmolding 8, which covers the permanent magnet elements 5. This outside diameter 9 of the rotor 4 must not be greater than the inside diameter 10 of the stator 2 so that the rotor can be slid into the stator 2 during assembly (FIG. 6). However, all that is necessary to feed the rotor 4 into the stator 2 is that, at the one end of the rotor 4, the outside diameter 9 is the same as the inside diameter 10 of the stator. It can be advantageous when the outside diameter 9 at the other end of the rotor 4 exceeds the magnitude of the inside diameter 10 of the stator 2, as the rotor 4 can then only be slid into the stator 2 up to this point. The end of the rotor 4, the outside diameter 9 of which is not greater than the inside diameter 10 of the stator 2, can be used as an assembly aid for the electric motor 1, as the rotor 4 cannot be pulled against the stator 2 by the permanent magnet elements 5 when it is slid into the stator 2 due to the overmolding 8.

FIG. 3 is a lateral section through the rotor 4. The rotor 4 is mounted on the axis 6 by a bearing. The permanent magnet elements 5, which in this case are cuboid-shaped, can be seen on the rotor 4. The permanent magnet elements 5 have an axial extension 7. This axial extension 7 extends beyond the extension of the stator 2. That part of the permanent magnet elements 5 which extends beyond the extension of the stator 2 is provided with an overmolding 8. This overmolding 8 is usually made of plastic. The combination of the rotor 4 with the permanent magnet elements 5 fitted thereto and the overmolding 8 of the permanent magnet elements 5 has an outside diameter 9 which, at least at one end of the rotor 4, must not be greater than the inside diameter 10 of the stator 2. Two sections along the line A-A and the line D-D, which are described in the following FIGS. 4 and 5, are shown through the figure in FIG. 3.

FIG. 4 shows a section through the rotor 4 along the line D-D from FIG. 3. The rotor 4, on which the cuboid-shaped permanent magnet elements 5 are arranged, can again be seen. These permanent magnet elements are encompassed by an overmolding 8. The overmolding 8 fixes the permanent magnet elements 5 on the rotor 4. In addition, the overmolding 8 is formed in one piece with bars 11 that engage in the rotor 4 between the permanent magnet elements 5. To fix the bars 11 in the rotor 4 in an optimum manner, undercuts 12, into which the plastic material flows during the formation of the bars 11 and which have the effect of an additional anchoring of the bars in the rotor 4, are made in the rotor. It can be clearly seen that the overmolding 8 is formed in one piece with the bars 11, wherein the overmolding 8 together with the bars 11 form a cage in which the permanent magnet elements 5 are mounted securely and permanently.

The section according to line A-A from FIG. 3 is shown in FIG. 5. The rotor 4, on which the permanent magnet elements 5 are fixed by the overmolding 8, can also be seen here. In addition, the bars 11 formed in one piece with the overmolding 8 and which engage in undercuts 12, can again be seen, wherein the cage comprising overmoldings 8 and bars 11 once again guarantees a secure retention of the permanent magnet elements 5.

FIG. 6 again shows a schematic structure of the electric motor 1 according to one embodiment of the invention in a sectional view. The stator 2 and the rotor 4 can be seen. The permanent magnet elements 5 are mounted on the rotor 4. The permanent magnet elements 5 project beyond the stator 2 in their axial extension. Only that part of the permanent magnet elements 5 that projects beyond the stator 2 is covered by a plastic overmolding 8. This overmolding 8 fixes the permanent magnet elements 5 in their position on the rotor 4. As the permanent magnet elements 5 in the region of the stator 2 are not covered with plastic, the air gap 13 can be formed directly between the stator 2 and the permanent magnet element 5. As a result, the distance between the stator 2 and the permanent magnet element 5 is particularly small, which leads to an improvement in the performance capability of the electric motor 1.

As a result of the short distance from the permanent magnet elements 5, the magnetic fields emanating from the stator 2 can produce significantly larger forces and therefore torques in the electric motor 1 than with the solutions according to the prior art, of which one is shown by way of example in FIG. 7.

An electric motor according to the prior art is shown in FIG. 7. Here too a stator 2 and a rotor 4 can be seen. Permanent magnet elements 5 are arranged on the rotor 4. These permanent magnet elements 5 are encompassed by a plastic overmolding 14. It should be pointed out that differentiation is made in this patent application between an overmolding 8 and an overmolding 14. The overmolding 8, as shown in FIG. 6, covers only those parts of the at least one permanent magnet element 5 that extend beyond the stator 2. The overmolding 14, as shown in FIG. 7, completely covers the permanent magnet elements 5. This complete covering of the permanent magnet elements 5 with the overmolding 14 increases the distance between the permanent magnet elements 5 and the stator 2 by at least the thickness of the overmolding 14. The distance between the stator 2 and the permanent magnet elements 5 is therefore made up of the thickness of the overmolding 14 and the necessary air gap 13. As the field strength of a magnetic field reduces with the distance from its source, the force produced by the electric motor is reduced by increasing the distance between the stator 2 and the permanent magnet elements 5.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. An electric motor comprising:
a stator on which at least one coil for producing a commutated magnetic rotating field is formed;
a rotor, on which at least one permanent magnet element is arranged, wherein the rotor is rotatably mounted on an axis and a force that turns the rotor about the axis acts between the commutated magnetic rotating field and a magnetic field of the permanent magnet element;
an axial extension of at least one end of the at least one permanent magnet element that projects beyond the stator;
a plastic overmolding that covers only that part of the permanent magnet element that projects beyond the stator, wherein the plastic overmolding fixes the permanent magnet element in its position on the rotor; and
bars formed in one piece with the overmolding, the bars being anchored in the rotor and additionally fix the at least one permanent magnet element.

9. The electric motor as claimed in claim 8, wherein the permanent magnet element projects beyond the stator in its axial extension at both ends, wherein only those parts of the permanent magnet element that project beyond the stator are covered by plastic overmoldings.

10. The electric motor as claimed in claim 8, wherein, an outside diameter of the rotor with the overmolding is no greater than an inside diameter of the stator at least at one end of the rotor.

11. The electric motor as claimed in claim 8, wherein the anchoring of the bars is an undercut.

12. The electric motor as claimed in claim 8, wherein the at least one overmolding is configured as an aid for installing the rotor in the stator.

13. The electric motor as claimed in claim 8, wherein the permanent magnet element is cuboid-shaped.

14. The electric motor as claimed in claim 9, wherein, an outside diameter of the rotor with the overmolding is no greater than an inside diameter of the stator at least at one end of the rotor.

15. The electric motor as claimed in claim 14, wherein the at least one overmolding is configured as an aid for installing the rotor in the stator.

16. The electric motor as claimed in claim 14, wherein the permanent magnet element is cuboid-shaped.
